(19) United States
(12) Patent Application Publication
(10) Pub. No.: US 2013/0169785 A1
(43) Pub. Date: Jul. 4, 2013

(54) METHOD OF DETECTING AND IMPROVING OPERATOR SITUATIONAL AWARENESS ON AGRICULTURAL MACHINES

(71) Applicant: AGCO Corporation, Duluth, GA (US)

(72) Inventor: Paul Matthews, Bel Aire, KS (US)

(73) Assignee: AGCO CORPORATION, Duluth, GA (US)

(21) Appl. No.: 13/731,244

(22) Filed: Dec. 31, 2012

Related U.S. Application Data
(60) Provisional application No. 61/581,992, filed on Dec. 30, 2011.

(51) Int. Cl. B60Q 9/00

(52) U.S. Cl. CPC B60Q 9/008
USPC 348/77; 340/435

(57) ABSTRACT

Methods, systems and apparatus are presented that can warn a machine operator of an object in a machine path when an operator is not looking in the machine travel direction. A situational awareness detector (SAD) can be configured to determine operator orientation and operator sight direction or field of view. A SAD can be configured to determine machine or implement travel path and whether an object of interest such as a boundary, pond, rock pile, etc. is positioned within the travel path. By comparing operator line of sight or field of view with machine and/or implement travel path, a SAD can determine operator awareness of the object in the travel path. If an operator is unaware of the object, an alert can be provided. If a determination is made that an operator is aware of an object, a system of the invention can refrain from providing an alert.

### CROSS REFERENCE TO RELATED APPLICATIONS

This application claims priority to U.S. Provisional Application No. 61/581,992 filed Dec. 30, 2011, entitled “METHOD OF DETECTING AND IMPROVING OPERATOR SITUATIONAL AWARENESS ON AGRICULTURAL MACHINES”.

### FIELD OF INVENTION

This invention relates generally to occupant detection systems, and more specifically to operator awareness systems at a vehicle or machine.

### BACKGROUND

Automobile and machine manufacturers are continually striving to enhance passenger safety by both active and passive means. For example, operator presence detection systems are often deployed as safety features in consumer as well as commercial vehicles and machines. One of the most common operator presence devices is a pressure-sensitive sensor positioned underneath a passenger seat. For example, a seat sensor can be used in conjunction with an airbag deployment system to detect the presence of an occupant and as a check that a passenger's weight satisfies a minimum weight requirement for safe airbag deployment.

Seat sensors can also be deployed in agricultural machines as a means to insure that an operator is present and in control of a machine while a power take-off (PTO) is turned on. Agricultural fields can cover large areas, with a single pass taking up to an hour at a machine's relatively slow speed. Operator shifts can be up to 12 hours, a long time to remain seated, and some operators cannot resist the urge to get up and stretch or take a break while a machine is running. A seat sensor can be used to detect a vacant seat and shut down a PTO in response. Unfortunately, a seat sensor is easily exploitable by an operator who wants to avoid PTO down time, for example he may simply place a weight in the seat, or disconnect the seat switch, defeating its purpose, and placing an operator, his machine and his environment at risk.

Even when working properly with a seated operator, a seat sensor is limited to confirming an operator's presence, not his attention to machine operations. An operator may be drowsy and nodding off, be distracted by an entertainment system, or simply be occupied with looking behind the machine at a towed implement rather than looking ahead in the direction that a machine is heading; a dangerous situation when a machine is not equipped with an automatic guidance system. An accident can occur when an operator fails to notice an upcoming obstacle due to any of the above-mentioned reasons.

Some types of systems for checking or encouraging operator attention have been proposed, such as requiring an operator to push a button at periodic intervals, or flashing a message on a control display screen that invites an operator to respond. However, these types of systems can cause frustration and irritation on the part of an operator and are most often considered a nuisance that an operator wants to avoid. Thus, a nuanced approach is required, one that gauges an operator's awareness, is not easily circumvented, and is not invasively annoying to an operator.

### OVERVIEW OF THE INVENTION

A system is presented for determining an operator's situational awareness and, dependent on his awareness, warning him when his vehicle is approaching an obstacle or predetermined location. In an example embodiment, a system of the invention can be configured to determine the direction that an operator is looking. If the operator is not looking in the direction of machine travel, the system can alert him to an upcoming obstacle or marked position in his travel path. However, if the operator is looking in the direction of machine travel, and thus is able to see the obstacles in the machine/implement path, no alert is provided. Thus the system can enhance operator safety without providing unnecessary alarms that can either annoy an operator, or simply be ignored as part of an “alarm overload” condition at a machine in which multiple alarms are provided at such frequent intervals that an operator simply ends up ignoring them as routine.

In an example embodiment, a system can include an optical and/or infrared camera or other sensor coupled to a situational awareness detector (SAD). A camera can be mounted in an upper region of a cab in an unobtrusive location. In an example embodiment, camera input can be monitored so that an effort by an operator to cover, disconnect, or otherwise circumvent the system can be thwarted. In an example system, predetermined locations, such as ponds, ends of rows, fences, turns, angles and the like can be provided by a user and stored at a SAD as marked locations or objects that require an operator's attention. In addition, a dynamic obstacle detector, such as ladar or radar detector can be used to detect objects such as large rock piles in the path of a machine or machine implement. A SAD can be configured to compare the location of predetermined marked locations and dynamically detected objects to a machine's travel path to determine whether the object lies therein. In addition, a SAD can be configured to determine an operator's awareness of an upcoming obstacle in his machine path by determining whether the machine path or object is within an operator's gaze.

In an example embodiment, a SAD can comprise an operator orientation module (OOM) configured to determine an operator sight direction; a machine path module (MPM) configured to determine the path that a machine and/or its implement is headed; an object presence module (OPM) configured to determine whether an object is present within the machine travel path, and an operator awareness module (OAM) configured to determine operator awareness of an object, for example by determining whether a machine travel path is within a line of sight or field of view of an operator. In an exemplary embodiment, the OAM can be configured to determine whether a particular object in the machine path is within the view of an operator. When a determination is made that an operator is not aware of an object in his machine's path, an example SAD can be configured to provide an alert.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 shows an example embodiment;

FIG. 2A shows a block diagram of an example situation awareness detector (SAD);

FIG. 2B shows a block diagram of an example model of the invention;

FIG. 3 shows an example embodiment;

FIG. 4A shows a flow diagram of an example method; and

FIG. 4B shows a flow diagram of an example method.

Corresponding reference characters indicate corresponding parts throughout the views of the drawings.

### DETAILED DESCRIPTION OF EXAMPLE EMBODIMENTS

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the exemplary embodiments are discussed in the context of an agricultural vehicle, it will be understood that the present invention is not limited to that particular arrangement. Likewise functions discussed in the context of being performed by a particular module or device may be performed by a different module or device without departing from the scope of the claims.

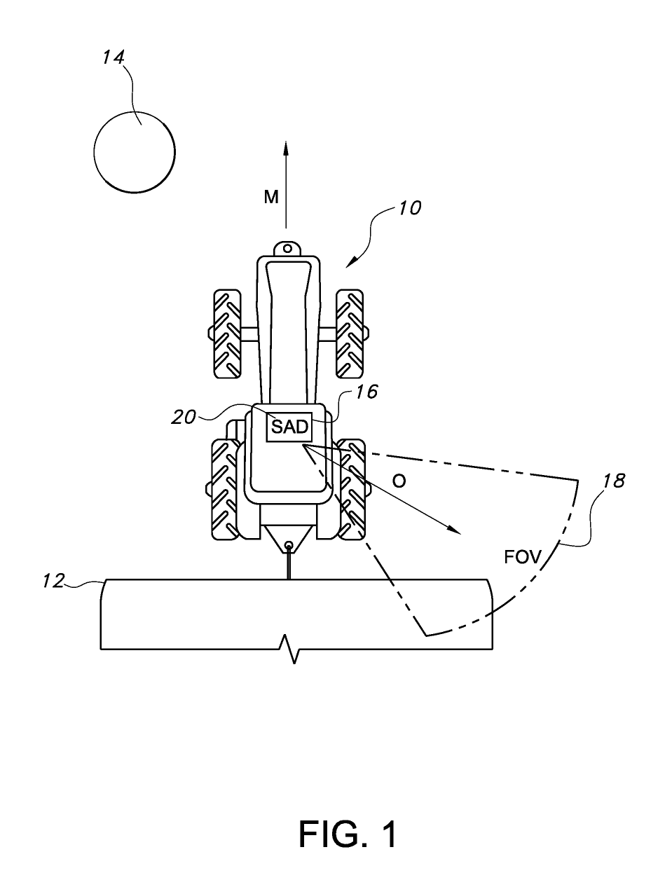

FIG. 1 shows a machine 10 traveling in the direction indicated by the arrow M and towing an implement 12 behind it. The machine 10 is approaching an object 14 that is in the path of the implement 12. In the course of cultivating or harvesting a field, a large number of rocks can be tilled up out of the ground. It is a common practice to accumulate these rocks in large rock piles in various field locations. The object 14 can be a large rock pile, a pond, debris, a piece of equipment, or any other sort of object or obstacle that poses an obstruction to the implement 12. A machine operator (not shown) occupies a cabin 16 of the machine 10. The operator is looking in a direction indicated by the arrow O, and has a field of view (FOV) 18. It is common practice for an operator to watch the progress of the towed implement 12 to see if the current implement pass is aligned with a previous pass and to make sure that the implement is operating properly. As indicated in FIG. 1, the operator is looking to the side and behind him and can see the implement 12 as it is towed, but cannot see the object 14 ahead. A situational awareness detector (SAD) 20 can determine the direction O that an operator is looking and provide an alert that the machine 10 is approaching the object 14 when the operator is looking in a direction other than that of the machine 10 travel direction.

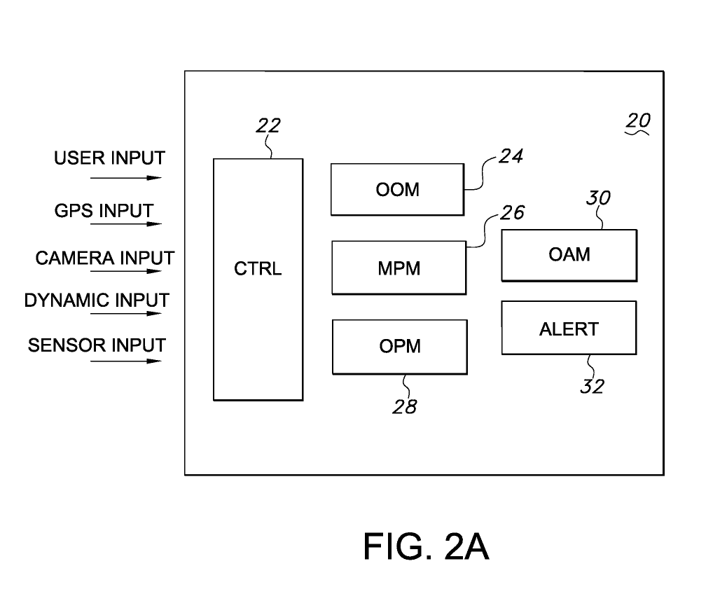

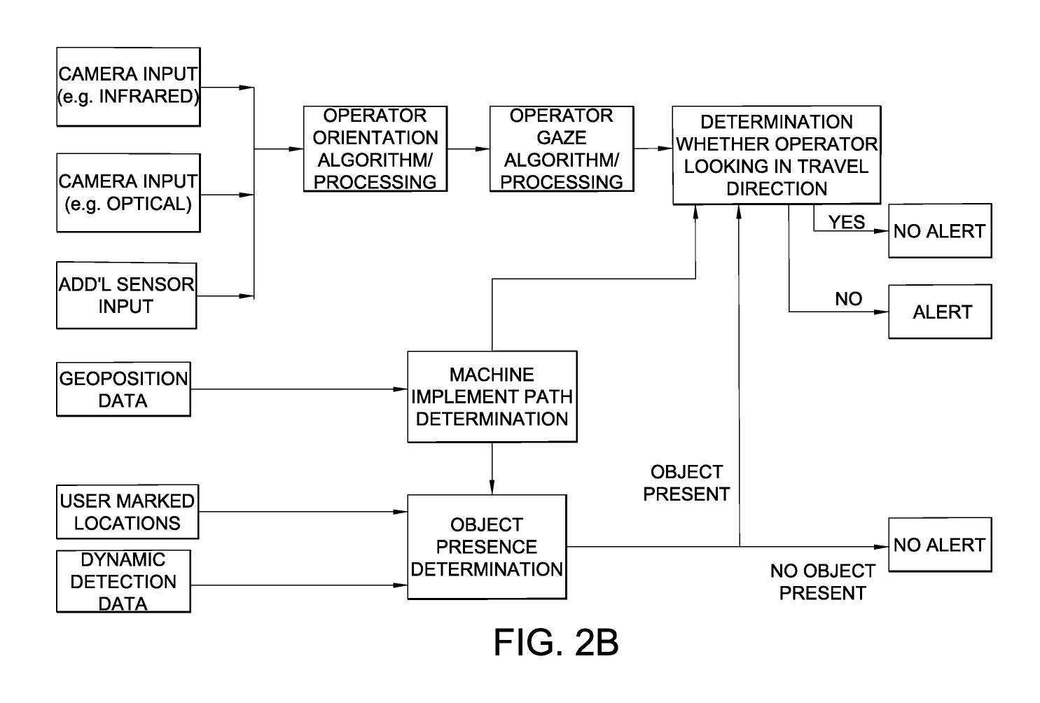

FIG. 2A shows an example embodiment of the SAD 20, which will be discussed in conjunction with a non-limiting example model of the invention depicted in FIG. 2B. Referring to FIG. 2A, an example embodiment of the SAD 20 can include a controller module (CTRL) 22, an operator orientation module (OOM) 24, a machine path module (MPM) 26, an obstacle presence module (OPM) 28, an operator awareness module (OAM) 30 and an alert module 32. Each of the modules 22-32 can comprise hardware, software, firmware or some combination thereof. In an example embodiment, the CM 22 can comprise a processor configured to receive input, coordinate interaction between modules 24-32, execute algorithms associated with the modules 24-32, as well as performing other processing functions and operations.

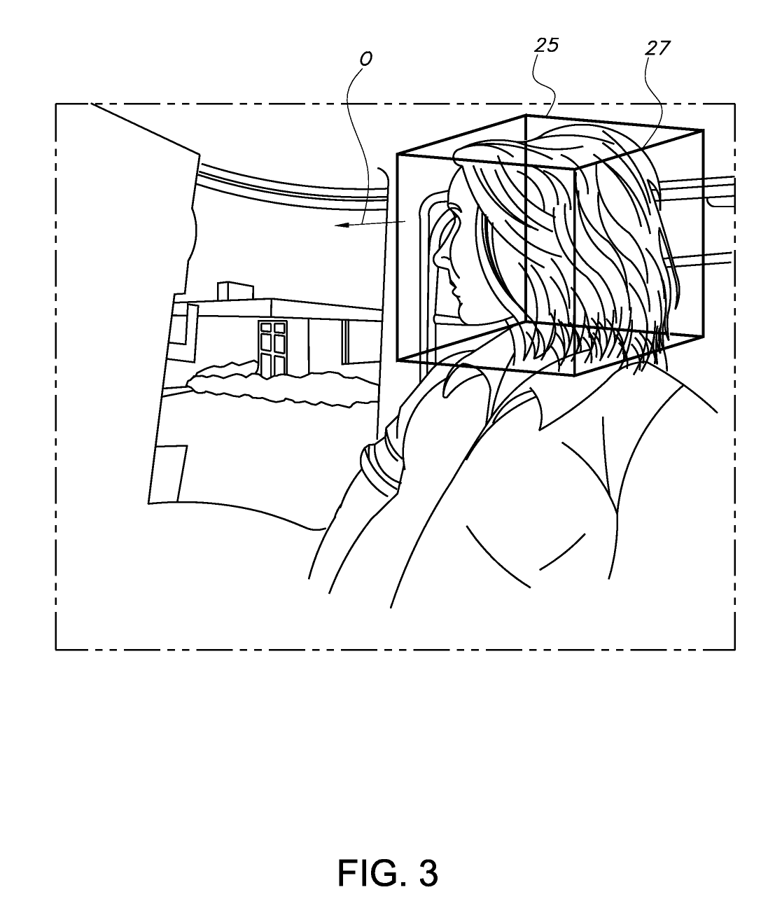

In an example embodiment, the OOM 24 can be configured to determine the orientation of an operator positioned in the cab 16. For example, the OOM 24 can use sensor input provided by one or more optical and/or infrared cameras or other sensors positioned in the cab 16 to determine operator orientation. In an example embodiment, one or more sensors/cameras can be positioned in various locations throughout the cab, such as at the front of the cab facing rearward, the rear of the cab facing forward, and at the sides of the cab 16 facing inward. The OOM 24 can comprise one or more image processing, pattern recognition, face detection or other algorithms configured to detect an operator and determine the orientation of an operator's head to determine the direction that an operator is looking. For example, algorithms for multi-perspective multi-modal systems such as those discussed in “Multiperspective Thermal IR and Video Arrays for 3D Body Tracking and Driver Activity Analysis”, by Shinko Cheng, Sangho Park, and Mohan Trivedi and published at the 2^{nd} Joint IEEE International Workshop on Object Tracking and Classification in and Beyond the Visible Spectrum in conjunction with IEEE CVPR2005, San Diego Calif., USA. June, 2005, which is incorporated in its entirety by reference, can be practiced and/or modified to analyze and track the head and face gaze direction of an operator. In an example embodiment, methods such as those disclosed in the article entitled, “Image-Based Passenger Detection and Localization Inside Vehicles”, authored by Petko Faber and published in the International Archives of Photogrammetry and Remote Sensing, Vol. XXXIII, Part B5, pages 231-232, Amsterdam 2000, which is incorporated in its entirety by reference, can be practiced and/or modified. In addition, algorithms similar to those used for video gesture control and 3D depth camera video gesture control in the gaming industry can also be employed. For example, the GestureTek™ Maestro 3D software configured to track a user's movements within a volume of interest to allow a user to have device-free control, such as that employed in Kinect™ video games, can be adapted to track a user's head. For example, referring to FIG. 3, a volume of interest 25 can be configured around an operator's head 27 to determine his orientation and line of sight as indicated by the arrow O. In an example embodiment, algorithms described in U.S. Pat. No. 7,898,522, entitled “Video-based Image Control System” issued to Hildrith on Mar. 1, 2011, can be adapted to determine operator orientation and gaze direction. In an example embodiment, head orientation can be determined, and from that, the directional gaze. As an example, directional gaze can be expressed in terms of bearing. By way of example, but not limitation, the FOV 18 for an operator can be determined by knowing the bearing of the line of sight as indicated by the arrow O. For example a FOV can be defined as a predetermined area or cone or volume having the operator line of sight as its center.

The MPM 26 can be configured to determine the travel path for the machine 10 and implement 12. In an example embodiment, the controller 22 can receive input from a satellite receiver configured to determine current geographical location using satellite signals as known in the art for Global Positioning System (GPS) and Global Navigation Satellite System (GNSS) receivers. In addition, user input, such as the width of a towed implement can be received. The MPM 26 can use the geographical location and implement data to determine the machine travel path, which can be characterized by a heading and a width defined by latitude or longitude parameters.

The OPM 28 can be configured to determine whether an object is present in the machine travel path. In an example embodiment, a user can input predetermined marked locations of known obstacles or objects of interest, such as fencing, a pond, end of row, an angled turn, and the like. For example, latitude and longitude parameters can be provided and stored in a memory or database at the OPM 28. The OPM 28 can be configured to receive machine travel path information from the MPM 26 and determine whether the predetermined marked location parameters lie in the path defined at the MPM 26. In addition, a dynamic obstacle detection means can provide input regarding detected obstacles. For example, a radar, ladar or other type of detector can be configured to detect objects within its line of sight to provide input regarding obstacles that may not have been previously known, such as rock piles that have been formed in the course of working a field. In an example embodiment the radar detector can be configured to provide the heading and distance to the detected object. In an example embodiment, the detector acquires measurements through an arc that covers the width of the implement 12. In an exemplary embodiment, the machine path determined at the MPM 26 can be provided to the detector via a CAN bus (not shown) at the machine 10. Radar messages of suitable signal strength and within a predetermined proximity can be checked to see if they occur within the machine path. If sufficient measurements occur within the machine path, then an obstacle message providing obstacle position can be sent to the SAD 20 via the CAN bus. In a further embodiment, cameras can be used for obstacle detection, with video data transferred to the OPM 28 via the CAN bus. The OPM 28 can include one or more image processing algorithms known in the art for obstacle detection.

The OAM 30 can be configured to determine operator awareness of an upcoming object in his machine's path. In an example embodiment, the OAM 30 can be configured to compare the operator sight direction with the machine travel direction to determine whether an operator is aware of the machine travel path and any obstacles therein. In an example embodiment, line of sight bearing can be provided or field of view can be provided by the OOM 24 in terms of parameters such as a range of bearings or a range of latitude and longitude coordinates. If machine path as defined by the MPM 26 falls within the operator FOV 18, then a determination can be made that the operator is aware of the objects in the machine path. If not, then a determination can be made that an operator is not aware of a machine path, and thus not aware of any obstacles therein.

In an example embodiment, the OPM 28 can be configured to provide locations of objects that are within a machine's travel path to the OAM 30 and the OAM 30 can be configured to determine whether the object locations are within the operator line of sight or FOV provided be the OOM 24. If a determination is made at the OAM 30 that an operator is not aware of an object in the machine travel path, the OAM 30 can be configured to trigger the alert module 32 to provide an alert, preferably an audible alert. In an example embodiment, the OAM 30 can be configured to trigger the alert module 32 when the object is within the travel path and within a predetermined proximity of current machine location. For example, the OAM 30 can receive current geographic position from a GPS receiver at the machine 10, or from the MPM 26 and compare current location to the location coordinates for an object in the machine path as received from the OPM 28. In an example embodiment, an alert message can be sent to a speaker of an onboard audio system within the cab 16, for example via a CAN bus at the machine 10. In an example embodiment, as the distance between a machine and the object in its path narrows, an alert can be provided with increased urgency.

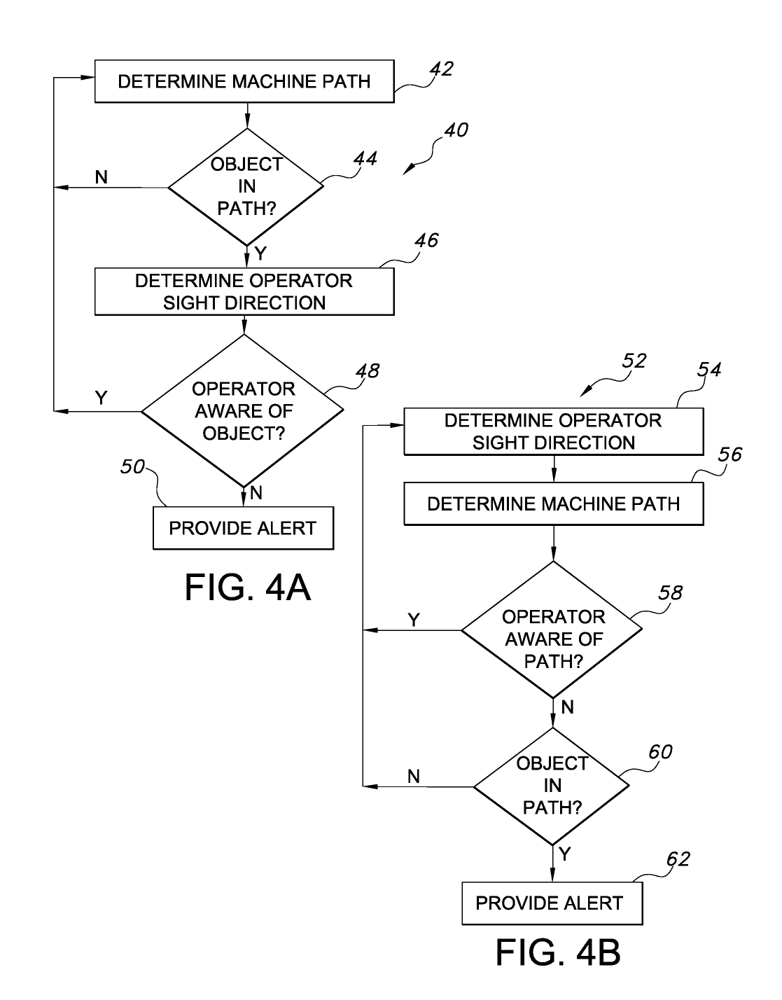

FIG. 4A shows an example method 40 that can be practiced to determine operator situational awareness. At block 42 a machine travel path can be determined. For example, the MPM 26 can determine a current travel path defined by boundaries for a machine with a towed implement using GPS position data and implement width. At decision block 44 a determination can be made as to whether an object lies within the current machine path. For example, the OPM 28 can determine whether location parameters associated with a predetermined marked location, and those associated with a dynamically detected object, fall within the region defined by a projected machine track that is based on current machine 10 location, implement width, and heading. Machine speed can be used to determine object proximity. In an example embodiment, a dynamic detection means, such as a radar detector can be configured to detect and/or report obstacles within an area that includes the machine path, but excludes objects beyond the machine path. If there is no obstacle in a machine travel path, the method 40 can continue at block 42.

If it is determined that an object is present within the machine path, the method 40 can continue to block 46 where a determination can be made regarding operator sight direction. In an example embodiment, the OOM 24 can use camera input to determine the orientation of an operator, particularly an operator's head, and an operator's line of sight direction. In an example embodiment, an operator FOV can be determined based on the line of sight.

At decision block 48 a determination can be made as to whether an operator is aware of the obstacle in the machine path. In an example embodiment, the OAM 30 can use the operator sight of direction or FOV provided by the OOM 24 and the machine path provided by the MPM 26 to make this determination. If the machine path is within the operator FOV, or its heading is within a predetermined angle of an operator line of sight, a determination can be made that an operator is aware of the object. It is also contemplated that in an example embodiment the OPM 28 can provide locations of objects or obstacles that are in the machine path, and the OAM 30 can determine whether those locations are within an operator FOV. If it is determined that an operator is aware of an object, the method can continue at block 42. If the determination is made that an operator is not aware of the obstacle, then an alert can be provided at block 50. For example, the OAM 30 or controller 22 can trigger an alarm at the cab 16. In an example embodiment, the alarm can increase in urgency, such as increased volume or frequency as the machine 10 approaches the object. In an example embodiment, the alarm can be triggered when the machine is within a predetermined distance of the object.

It is noted that a method of the invention can include various sequences of the blocks depicted in FIG. 4A. If performed sequentially, the method 40 can require that an object be detected in the machine path prior to performing the image processing algorithms practiced to determine operator orientation and line of sight. Thus, if no object is within the machine path, a processor need not execute the operator orientation algorithms. As shown in FIG. 4B, a method 52 of the invention can first determine operator orientation at block 54, and travel path at block 56. If it is determined at block 58 that an operator is looking in the direction of travel, then no obstacle in path determination need be made as it can be determined that an operator is viewing the machine path and is thus aware of any obstacles therein. However, if the operator is not looking in the direction of travel, at block 60 a determination can be made as to whether an object is in the travel path. If so, an alert can be provided at block 62. Otherwise, the method 52 can continue at block 54.

Thus the invention provides systems, apparatus, methods for warning an operator of an obstacle in a machine implement. The invention improves the safety of operator and machine during field operations, is not easily exploitable, and does not overload an operator with annoying or unnecessary alarms or distractions. In an example embodiment, one or more sensors such as cameras can be mounted in unobtrusive locations to detect an operator's presence and orientation. By way of example, but not limitation, a method can include checking sensor, for example camera input, to insure that the camera has not been disabled or covered. The invention can detect the presence of obstacles in a machine's path and make a determination regarding operator object awareness by comparing an operator gaze direction or field of view with a machine path direction. In an example embodiment, an operator is only warned when he is unaware of the object, for example in the case that is he is looking in a direction other than that of the machine travel path.

What is claimed:

1. A system, comprising:
a sensor configured to detect an operator; and
a situational awareness detector (SAD) coupled to said sensor and configured to determine whether an operator is looking in the direction of machine travel, and if not, to alert said operator to an obstacle present in said machine path.

2. The system of claim 1, wherein said sensor comprises a camera.

3. The system of claim 1, further comprising a second sensor configured to detect an object in said machine path.

4. The system of claim 1, configured to receive geographical position data from a satellite navigation receiver.

5. The system of claim 1, further comprising an alarm.

6. The system of claim 1, configured to provide no alert when said operator is looking in said direction of machine travel.

7. The system of claim 1, configured to provide no alert when an object is located within said operator's field of view.

8. A situational awareness detector (SAD), comprising:
an operator orientation module (OOM) configured to determine an operator sight direction;
a machine path module (MPM) configured to determine a path in which a machine is headed;
an object presence module (OPM) configured to determine the presence of an object in the path of said machine;
an operator awareness module (OAM) configured to determine whether said operator is looking in direction of said machine path; and
an alert module configured to provide an alert to said operator when said object is present in said machine path and said operator is not looking in said machine travel direction.

9. The SAD of claim 8, configured to provide no alarm when a determination is made that said operator is looking in said machine travel direction.

10. The SAD of claim 8, configured to receive user input regarding predetermined marked locations.

11. The SAD of claim 8, configured to receive dynamic obstacle detection input.

12. The SAD of claim 8, wherein said OOM is configured to receive optical sensor input.

13. The SAD of claim 8, wherein said OOM is configured to receive infrared sensor input.

14. The SAD of claim 8, wherein said OAM is configured to determine whether said object in said machine path is within said operator field of view.

15. A method, comprising:
determining whether a vehicle is approaching an object;
determining whether said vehicle operator is looking in said vehicle travel direction; and
alerting said operator when said vehicle is approaching said obstacle and said operator is not looking in said vehicle travel direction.

16. The method of claim 15, wherein said determining whether said vehicle is approaching an object comprises determining a machine implement travel path.

17. The method of claim 16, wherein said determining whether said vehicle is approaching an object comprises determining whether a predetermined marked location lies within said machine implement travel path.

18. The method of claim 16 wherein said determining whether said vehicle is approaching an object comprises determining whether a dynamically detected object lies within a machine implement travel path.

19. The method of claim 15, wherein said determining whether said operator is looking in a vehicle travel direction comprises determining said operator orientation.

20. The method of claim 19, wherein said determining said operator orientation comprises determining said operator head orientation.

21. The method of claim 20, further comprising determining said operator gaze direction from said operator head orientation.

22. The method of claim 15, wherein said alerting said operator when said vehicle is approaching said object and said operator is not looking in said vehicle travel direction comprises alerting said operator when said object is not within said operator field of view.

23. The method of claim 15, wherein said alerting comprises triggering an audible alarm.

24. A method, comprising:
determining a field of view (FOV) of an operator of a vehicle;
determining whether an object is in the path of the vehicle; and
determining whether the object is in the FOV.

25. The method of claim 24, further comprising:
actuating an alert if the object is not in the FOV.

26. An apparatus, comprising:
an operator orientation module (OOM) configured to determine a field of view of an operator of a vehicle;
an object presence module (OPM) configured to determine whether an object is in a path of the vehicle; and
an operator awareness module (OAM) configured to determine whether the object is in the field of view.

27. The apparatus of claim 26, further comprising:
an alarm configured to alert an operator if the object is not in the FOV.

28. The apparatus of claim 26, wherein the OPM is configured to detect a user provided obstacle.
